(19) United States
(12) Patent Application Publication
(10) Pub. No.: US 2004/0220959 A1
(43) Pub. Date: Nov. 4, 2004

(54) Methods and apparatus to enable system configuration during operating system runtime

(76) Inventors: Michael A. Rothman, Gig Harbor, WA (US); Vincent J. Zimmer, Federal Way, WA (US)

Correspondence Address: GROSSMAN & FLIGHT LLC, Suite 4220, 20 North Wacker Drive, Chicago, IL, 60606-6357, US

(21) Appl. No.: 10/427,319

(22) Filed: Apr. 30, 2003

(51) Int. Cl. G06F 17/00

(52) U.S. Cl. 707/102

(57) ABSTRACT

Methods and apparatus to enable system configuration during operating system runtime are disclosed. In one example, a disclosed method may include retrieving configuration information in a first format from a database, converting at least some of the configuration information from a first format into a second format and providing a user interface through which at least some of the configuration information in the second format is displayed to a user. The method may also include accepting input from a user via an input device, wherein the input includes alterations to the configuration information and altering the configuration of the system based on the input.

### TECHNICAL FIELD

The present disclosure is directed generally to computer systems and, more particularly, to methods and apparatus to enable system configuration during operating system runtime.

### BACKGROUND

Computing devices, such as personal computers, include a main circuit board (i.e., a motherboard) having a main processor to which a number of different peripheral devices (e.g., display drivers, disk controllers, network cards, etc.) may be connected to provide enhanced functionality to the motherboard. While a motherboard includes rudimentary computing functionality and some on-board peripherals (e.g., on-board network interfaces), motherboards rely on peripherals to, for example, control a compact disk (CD) drive, etc. Peripheral devices may be connected to the motherboard via a number of different interfaces including peripheral component interconnect (PCI) slots in the motherboard, universal serial bus (USB) connections, etc.

Each of the motherboard and any peripheral connected thereto includes memory in which firmware settings are stored. For example, a motherboard may include a non-volatile random access memory (NVRAM) device in which settings for the motherboard are stored. Similarly, a network card peripheral may include a NVRAM device in which settings for the network card are stored. Accordingly, firmware changes to motherboard or peripheral settings are affected by altering the contents of the NVRAM device having device firmware settings stored therein.

As will be readily appreciated by those having ordinary skill in the art, one of a number of different operating systems (OSs) can be installed on a computing device to be executed by the main processor so that, after the OS is booted, a graphical user interface is provided. For example, Windows XP®, Linux® or any other suitable OS may be installed on the computing system to provide a user with a runtime environment.

Throughout the life of a computing device having an OS installed thereon, it is typically necessary to change at least some of the settings stored in NVRAM on the motherboard and/or peripherals interfaced to the motherboard. Today, hardware vendors (e.g., motherboard vendors, peripheral vendors, etc.) provide OS-specific drivers configured to obtain settings from the motherboard and the peripherals interfaced thereto. The OS-specific drivers are further configured to enable modification of the settings stored in the NVRAM of the motherboard and the peripherals through a user interface. As will be readily appreciated by those having ordinary skill in the art, because each peripheral has an associated OS-specific driver that is typically stored on media (e.g., a high-density disk, a compact disk, etc.), numerous different pieces of media must be stored in safe places so that the drivers stored thereon are not lost. Lost drivers leave a user unable to make changes to system settings of the motherboard and/or various peripherals until a replacement driver is obtained from the motherboard or peripheral manufacturer.

The drivers that are used to read and/or change the settings stored in the NVRAM devices of the motherboard and the peripherals connected thereto are typically executed by inserting media (e.g., a high-density disk) into a drive prior to powering-up the computing system. When power is applied to the computing system, the main processor of the computing system begins a boot process during which various portions of firmware are loaded into memory from media and are executed. As part of the boot process of the computing system, the processor reads the information from the media and executes, in a pre-boot environment (i.e., an environment in which no OS is running), the driver that enables a user to obtain and change settings for particular devices. The pre-boot environment has limited resources and, therefore, interfaces provided by drivers for the motherboard and the peripherals may be crude and are usually unfamiliar to most users in contrast to the runtime environment provided after an OS is operating (e.g., a Windows® environment).

### BRIEF DESCRIPTION OF THE DRAWINGS

FIG. 1 is a block diagram of an example computing system including a configuration system.

FIG. 2 is a block diagram providing additional detail of the OS Agent of FIG. 1.

FIG. 3 is an illustration of a portion of an example user interface having an option unchecked.

FIG. 4 is an illustration of a portion of the example user interface of FIG. 3 having the option checked.

FIG. 5 is a block diagram of an example computing system on which the configuration system of FIG. 1 may be implemented.

FIG. 6 is a flow diagram of an example configuration process that may be carried out by the computing system of FIG. 5.

FIG. 7 is a flow diagram of an example OS Agent process that maybe carried out by the computing system of FIG. 5.

### DETAILED DESCRIPTION

The following describes example methods, apparatus and articles of manufacture that provide computing system configuration functionality during runtime using runtime resources. While the following disclosure describes configuration systems implemented by software or firmware executed by hardware, those having ordinary skill in the art will readily recognize that the disclosed systems could be implemented exclusively in hardware through the use of one or more custom circuits, such as, for example, application-specific integrated circuits (ASICs) or any desired combinations of hardware, software and/or firmware.

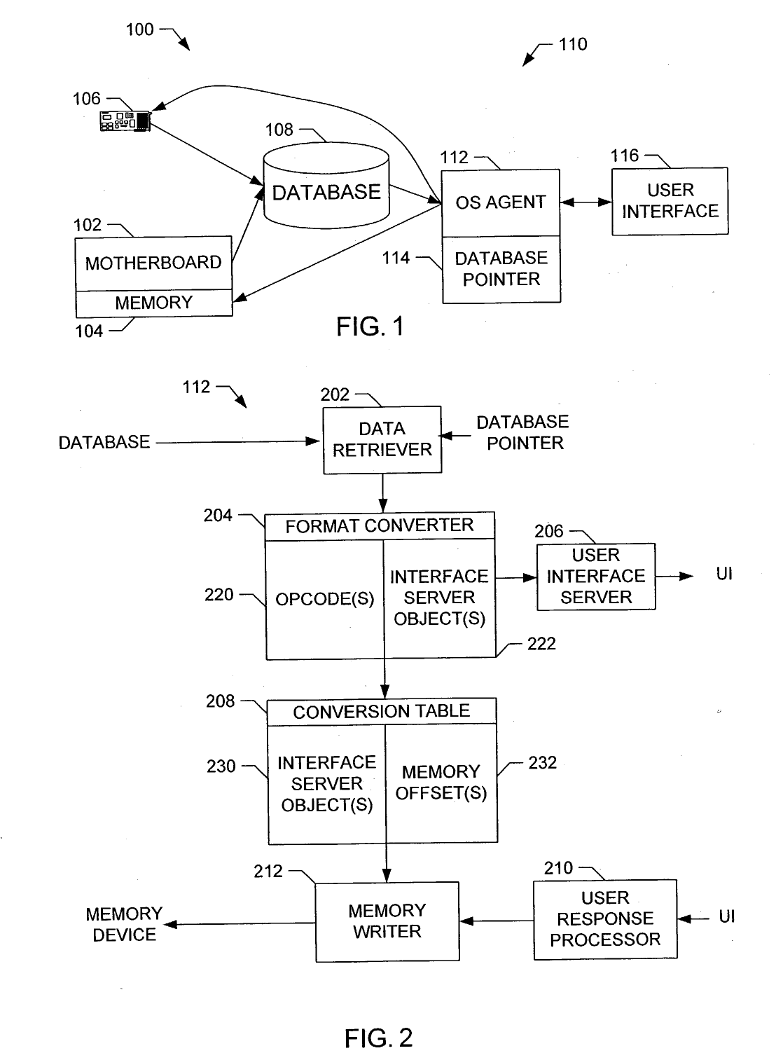

As shown in FIG. 1, an example computing system 100 includes a motherboard 102 having a memory 104, a peripheral device 106 and a database 108. The computing system 100 further includes a configuration system 110 including, for example, an OS Agent 112, a database pointer 114 and a user interface 116.

The motherboard 102 may be implemented using a motherboard or backplane that is commercially available from a number of computing system manufacturers (e.g., Compaq, Dell, Micron, etc.), as well as from a number of other vendors that sell components for use in computing systems. Among other components, the motherboard 102 includes a microprocessor (not shown) associated with the memory 104 in which settings relevant to the microprocessor, or, more generally, the motherboard 102 are stored.

The memory 104 may be, for example, non-volatile random access memory (NVRAM), flash memory, random access memory (RAM) or any suitable combination thereof. As noted previously, the memory 104 stores information, such as settings for the microprocessor or the motherboard 102. The stored settings may include indications of a language preference (e.g., English, Spanish, Kanji, etc.), the country in which the system 100 is located, whether the user desires the number lock (i.e., Num Lk) to be enabled automatically when the microprocessor of the motherboard 102 boots and/or any other settings that are typically found in the firmware associated with a computing system.

The peripheral 106 shown in FIG. 1 is any peripheral that may be interfaced to the motherboard 102. For example, the peripheral 106 could be a network interface device (e.g., an Ethernet card, a modem, a television reception card, etc.), an input/output (I/O) device (e.g., a display interface card, a disk controller, etc.) Further, while only one peripheral 106 is shown in FIG. 1 for example purposes, the system 100 could include additional peripherals.

The peripheral 106, like the motherboard 102, includes a memory (not shown) in which settings (i.e., firmware) for the peripheral 106 are stored. For example, the peripheral memory may store indications of a firmware version, language preferences, etc. The peripheral memory may be implemented using NVRAM, RAM, flash memory and the like.

The database 108 may be implemented using any electronic, magnetic or optical storage media and/or storage device. For example, the database 108 may utilize an entire or a portion of a hard drive that is interfaced to the motherboard 102 through a disk controller (not shown). Alternatively, the database 108 may be implemented using a compact disk (CD) and/or a digital versatile disk (DVD). In some instances, it may be particularly advantageous to implement the database 108 using a semiconductor memory such as RAM, flash memory, electrically erasable programmable read only memory (EEPROM), etc. For example, it may be desirable to implement the database 108 in RAM due to the easy accessibility of RAM in all phases of system evolution. Regardless of the media on which the database 108 is implemented, the database 108 of the disclosed examples is a self-describing database that may be accessed by one or more application program interfaces (APIs).

The OS Agent 112, as described in detail below may be implemented using dedicated hardware blocks or may be implemented using hardware that executes software or firmware instructions. In some instances, the OS Agent 112 may be executed in the pre-boot environment, while in other situations, the OS Agent 112 may be executed during runtime after the OS is booted and operational. Additionally, some portions of the OS Agent 112 may be performed during pre-boot and others may be performed during runtime.

The database pointer 114 may be information, such as an address or a data value stored in a memory location, a register or a buffer. For example the database pointer 114 may point to a location storing the database 108 from which, as explained below, information is read by the OS Agent 112. Alternatively, for example, the database pointer 114 may be a global unique identifier (GUID)/pointer pair that is written into a system table to identify the location of information in the database 108.

The user interface 116 may be any suitable graphical user interface, such as a Windows® generated interface (i.e., OS-generated) or a firmware generated interface, which presents information to a user. As described below, the user interface 116 enables a user to make selections for configurations of, for example, the motherboard 102 and/or the peripheral device 106. The user interface 116 may include hyperlinks, drop down menus and other graphical features used to display information, facilitate selections, navigate through information, etc.

During operation, configuration information from the motherboard 102 and the peripheral device 106 is provided to the database 108 and stored in a location identified by the database pointer 114. The configuration information from the motherboard 102 and the peripheral device 106 may be stored in the database 108 during pre-boot execution when each of the motherboard 102 and the peripheral device 106 is initialized. Alternatively, the database 108 may be populated during OS runtime.

The information provided to the database 108 by the motherboard 102 and the peripheral device 106 may have any number of different formats, such as, for example, an internal forms representation (IFR). As will be readily appreciated by those having ordinary skill in the art, an IFR is based on a binary encoding scheme in which console information, such as forms or strings, is represented in a programming language-agnostic manner. For example, as used herein, the IFR may be used to describe configuration information in a space-efficient, compact manner. As described below, the IFR may include, for example, opcodes and operands.

Once the IFR is stored in the database 108, the OS Agent 112 reads from the database 108 referenced by the database pointer 114. The OS Agent 112 reads the information, which may be, for example, IFR-formatted information, from the database 108 and converts the IFR-formatted information to a format that is compatible with user interfaces (e.g., hypertext mark-up language (HTML) or extensible mark-up language (XML)). The converted information is then presented to a user at the user interface 116. The user reviews the information presented on the user interface 116, makes changes thereto and, when the user is confident that the configuration information is correct, submits the changed information by, for example, clicking a submit icon presented on the user interface 116. The OS Agent 112 processes the information submitted by the user and makes changes to the configurations of the motherboard 102 and the peripheral device 106 based thereon by writing information to the memories of the motherboard 102 and the peripheral device(s) 106.

The information written to the motherboard 102 and the peripheral devices(s) 106 may be written to NVRAM components on the motherboard 102 and the peripheral device(s) 106. Alternatively, a central NVRAM device (not shown) may be provided to which the OS Agent 112 may write changes for any of the motherboard 102 and the peripheral device(s) 106. Regardless of whether the changes made by a user are written to devices on the components (e.g., the motherboard 102 and/or the peripheral device(s) 106) or to a central NVRAM device, the changes will be exported to the database 108 by the components when they are initialized.

As shown in FIG. 2, the OS Agent 112 may include a data retriever 202, a format converter 204 and a user interface server 206. The OS Agent 112 of the example of FIG. 2 also includes a conversion table 208, a user response processor 210 and a memory writer 212.

In operation, the data retriever 202 obtains from data from the database 108 that is identified by the database pointer 114. As noted previously, the information in the database 108 may be configuration information in an IFR format. The database pointer 114 may be for example, an indicator such as a GUID/pointer pair. For example, the motherboard 102 and the peripheral device(s) 106 write information into the database 108, which is pointed to by a GUID/pointer, via, an export agent. The GUID/pointer pair identifies the beginning of the database 108. For example, the GUID/pointer pair may identify the beginning of the database 108 and one or more APIs (e.g., the OS Agent 112 and/or the data retriever 202, etc.) may be used to pass information into and out of the database 108. Accordingly, during the operation of the OS Agent 112, the data retriever 202 copies the contents of the relevant memory locations, which include opcodes and operands in, for example, an IFR format.

The data retriever 202 passes data it obtains to the format converter 204, which converts the opcodes and operands into objects suitable for processing by the user interface server 206. By way of example, the format converter 204 may include a look-up-table of opcodes 220 and interface server objects 222 to which the opcodes correspond. For example, if the device setting under consideration is the default state of the number lock (Num Lk) function on the motherboard 102 on startup, IFR information representing the setting may be represented by Equation 1 below.

0x03 0x0c 0x22 Equation 1

In Equation 1:

0x03 is an opcode representing a binary state;

0x0 is an operand indicating that the binary state represented by the opcode is a logical zero (i.e., the number lock is off on motherboard startup); and

0x22 is an operand indicating an address of information to be presented as a text string associated with the opcode.

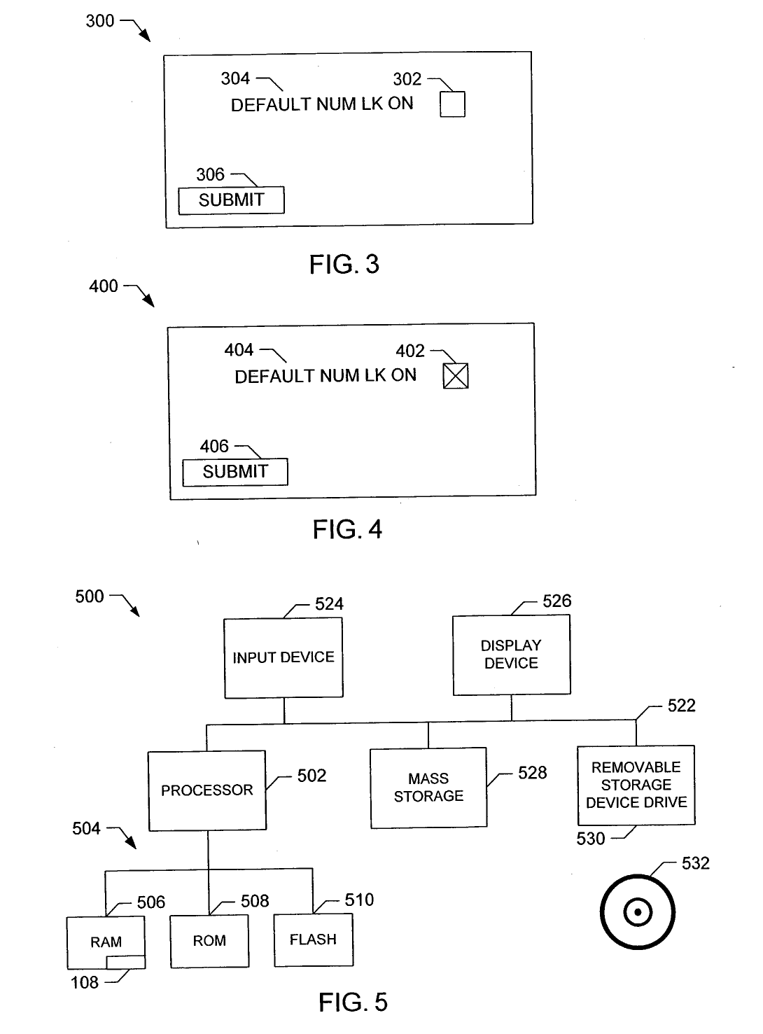

The format converter 204 processes each portion of opcodes and operands separately to convert IFR information into interface server objects that may be presented to the user on the user interface 116 via the user interface server 206. For example, considering processing of the opcode 0x03, an interface server object 222 corresponding to the opcode 0x03 is a checkbox that may have a default state and may have associated text. Accordingly, upon receiving the opcode 0x03, the format converter 204 finds that a checkbox corresponds to the opcode of 0x03. For example, as shown in FIG. 3, which is an example portion of a user interface 300, a checkbox 302 is generated in response to the 0x03 opcode.

The state of the checkbox 302 is determined by reading the first operand (0x0c). If the first operand is a logical one, the number lock checkbox 302 defaults to enabled (checked). Conversely, if the first operand is a logical zero, the number lock checkbox 302 defaults to disabled (unchecked). The format converter 204 generates a check box that is appropriately checked if number lock defaults to enabled and generates a checkbox that is unchecked if the number lock defaults to disabled. For example, the checkbox 302 shown in FIG. 3 is shown as unchecked, accordingly, the operand 0x0c corresponds to a logical zero.

The format converter 204 also processes the second operand 0x22, which corresponds to text associated with the opcode 0x03. If the contents of the memory location 0x22 and subsequent locations correspond to the text, “Default Num Lk on,” this text will be displayed on a user interface corresponding to the checkbox. For example, as shown in FIG. 3, the text 304 is displayed with the checkbox 302. Also shown on in FIG. 3 is a submit icon or button 306.

The checkbox 302 and associated text are converted to commands, such as XML commands that are passed to the user interface server 206. The user interface server 206 processes the information passed thereto by the format converter 204 and produces a display including elements representative of the user interface 300.

In addition to generating objects that may be handled by the user interface server 206, the format converter 204 populates the conversion table 208 with interface server objects 230 and memory offsets 232 corresponding to the objects. For example, the state of the checkbox 302 corresponds to a memory location of 0x0c.

When the user interface 300 is manipulated by a user (e.g., through the use of a mouse or any other user interface device) to check the checkbox 302, the result is a user interface 400 as shown in FIG. 4. Referring to FIG. 4, the user interface 400 shows a selected checkbox 402 having associated text 404, which is the same as the text 304 of FIG. 3. Additionally, the user interface 400 includes a submit icon 406 that may be selected by a user after the selection of the checkbox 402.

After a user manipulates the user interface 400 to, for example, check the checkbox 402, the user selects the submit button 406 to indicate that the user desires the changes to be made in the defaults of the motherboard memory 104. Upon selecting the submit button 406, the state of the objects (e.g., the checkbox 402) is passed to the user response processor 210, which interprets the states of the objects. For example, the user response processor 210 determines that the checkbox 402 has been checked. The user response processor 210 also determines if the states of the objects have changed. For example, the user response processor 210 determines that the checkbox was unchecked (as in FIG. 3) and is now checked (as in FIG. 4). The user response processor 210 passes the differences in object status (e.g., checkboxes that have changed state between checked and unchecked) to the memory writer 212. The information passed from the user response processor 210 to the memory writer 212 may include the identity of the object and the new state of the object.

Upon receiving the identity of the objects and the new states of the objects from the user response processor 210, the memory writer 212 accesses the conversion table 208 to determine the memory offset corresponding to the object identity passed to the memory writer 212 by the user response processor 210. Accordingly, the memory writer 212 writes to memory devices information corresponding to the new settings of the objects. For example, with continuing reference to the example of the number lock default, the state of the checkbox changed from unchecked 302 to checked 402. The memory writer 212 determines that the memory offset or location of the memory setting corresponding to the state change of the checkbox should be written to the location 0x0c. For example, the value of a logical one is written to the memory location 0x0c of the motherboard memory 104.

Although the foregoing describes motherboard setting changes that are carried out for changing the number lock, those having ordinary skill in the art will readily recognize that other settings for other system components other than the motherboard may be changed.

Turning now to FIG. 5, an example processor system 500 on which the disclosed processes may be executed includes a processor 502 having associated memory 504, which may be implemented using, for example, a random access memory (RAM) 506 (in which the database 108 of FIG. 1 may be implemented), a read only memory (ROM) 508 and/or a flash memory 510. The processor 502 and the memory 504 may be disposed on a motherboard (e.g., the motherboard 102 of FIG. 1). Additionally, the flash memory 510 may correspond to the memory 104 of FIG. 1. The processor 502 is coupled to an interface, such as a bus 522 to which other components may be interfaced. In the illustrated example, the components interfaced to the bus 522 include an input device 524, a display device 526 (including a driver card corresponding to the peripheral device 106 of FIG. 1), a mass storage device 528 and a removable storage device drive 530. The removable storage device drive 530 may include associated removable storage media 532. Such as magnetic or optical media.

The example processor system 500 may be, for example, a conventional desktop personal computer, a notebook computer, a workstation or any other computing device. The processor 502 may be any type of processing unit, such as a microprocessor from the Intel® Pentium® family of microprocessors, the Intel® Itanium® family of microprocessors, and/or the Intel XScale® family of processors. The memories 506, 508 and 510 that are coupled to the processor 502 may be any suitable memory devices and may be sized to fit the storage demands of the system 500. In particular, the flash memory 510 may be a non-volatile memory that is accessed and erased on a block-by-block basis.

The input device 524 may implemented by a keyboard, a mouse, a touch screen, a track pad or any other device that enables a user to provide information to the processor 502.

The display device 526 may be, for example, a liquid crystal display (LCD) monitor, a cathode ray tube (CRT) monitor or any other suitable device that acts as an interface between the processor 502 and a user. The display device 526 as pictured in FIG. 5 includes a peripheral device required to interface a display screen to the processor 502.

The mass storage device 528 may be, for example, a conventional hard drive or any other magnetic or optical media that is accessible via the processor 502.

The removable storage device drive 530 may, for example, be an optical drive, such as a compact disk-recordable (CD-R) drive, a compact disk-rewritable (CD-RW) drive, a (DVD) drive or any other optical drive. It may alternatively be, for example, a magnetic media drive. The removable storage media 532 is complimentary to the removable storage device drive 530, inasmuch as the media 532 is selected to operate with the drive 530. For example, if the removable storage device drive 530 is an optical drive, the removable storage media 532 may be a CD-R disk, a CD-RW disk, a DVD disk or any other suitable optical disk. On the other hand, if the removable storage device drive 530 is a magnetic media device, the removable storage media 532 may be, for example, a diskette or any other suitable magnetic storage media.

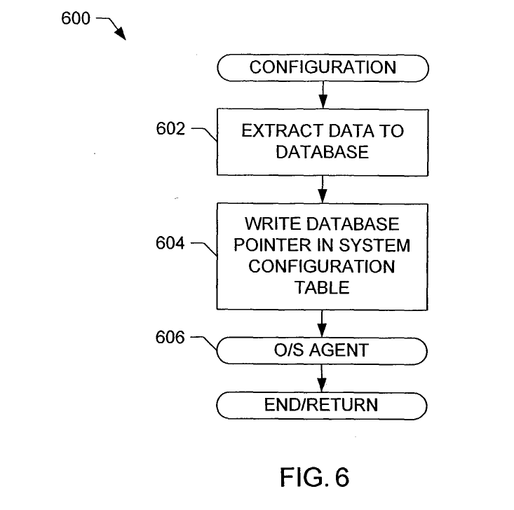

As shown in FIG. 6, a configuration process 600, which may be executed on the system 500 described in conjunction with FIG. 5, may be represented by a flow diagram including a number of blocks. The functionality represented by the blocks of FIG. 6 may be implemented using instructions that may, for example, be stored in memory 504 (e.g., the RAM 506, which may be static RAM (SRAM), dynamic RAM (DRAM) or any other suitable RAM device) and executed by the processor 502. While the blocks of the flow diagram of FIG. 6 are shown in a particular order, those having ordinary skill in the art will readily recognize that the functions associated with such blocks may be implemented in other orders than that shown in FIG. 6.

The configuration process 600 begins execution when information from the various components (e.g., the settings stored in memory of the components 102 and 106 of FIG. 1) is extracted to the database 108 (block 602). As will be readily appreciated, the transfer of information from the components to the database 108 may be initiated by, for example, a processor on the motherboard 102. For example, during pre-boot or runtime, the processor 502 may poll each of the devices connected thereto and may request each device to export settings. In the alternative, each device connected to the processor 502 may initiate their own exportation of the information to the database 108.

After information from the devices has been extracted to the database 108 (block 602), a pointer to the database location at which the device information is stored in the database 108 is written or published in a system configuration table maintained by the processor 108 via a pre-boot environment or an OS runtime environment (block 604). In one example, the information may be published in the form of a GUID/pointer pair. By publishing the database pointer in the system configuration table, various entities, drivers, tables, etc. can access information that indicates the location of the device information.

After the pointer to configuration information is noted in the system configuration table (block 604), an OS Agent process may be called for execution (block 606). For example, OS Agent process 606 may be called based on a user input or may be called by one or more portions of software or firmware executed by the processor 502. As will be readily appreciated by those having ordinary skill in the art, during the configuration process 600 described in conjunction with FIG. 6, an OS may be booted. For example, an OS may be booted between the time when the database pointer is written in the system configuration table and when the OS Agent process 606 is called (block 606). Accordingly, the OS Agent process 606 may be called during runtime of an operating system.

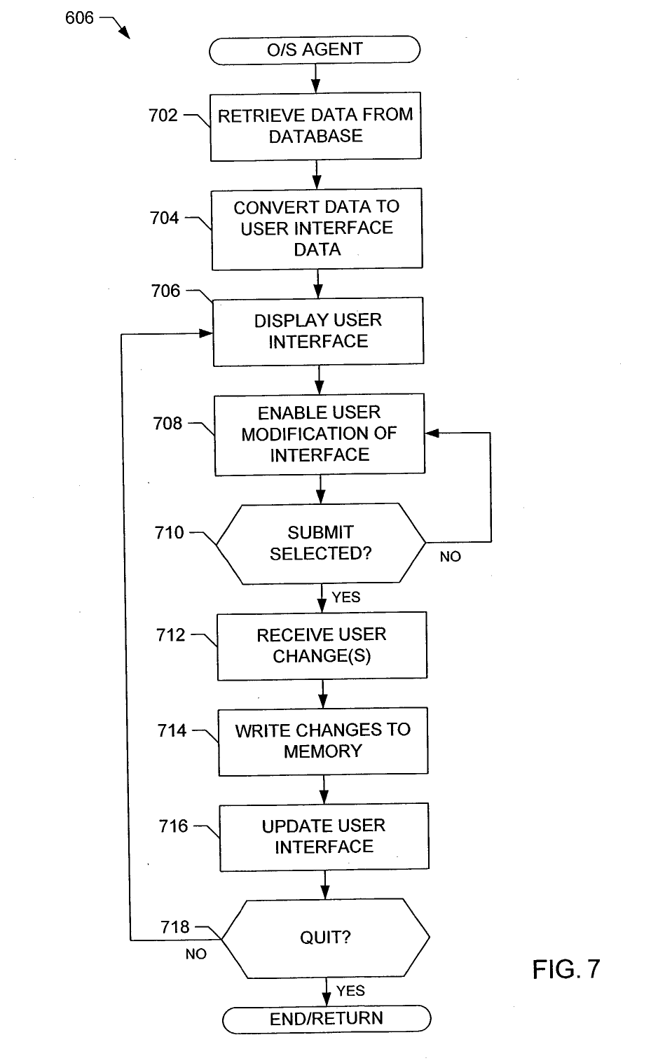

Turning to FIG. 7, additional detail on the OS Agent process 606 is shown. Initially, configuration data is retrieved from the database (block 702). Alternatively, if the configuration information is not resident in a database, the configuration information may be retrieved directly from the motherboard 102 and/or any peripheral(s) 106 coupled thereto. As noted previously, the configuration information may be in an IFR format having opcodes and operands associated with forms that represent the configuration data.

After the configuration information is retrieved (block 702), the configuration information is converted to a format that may be readily presented to a user via a user interface (block 704). In one example, the configuration information may be converted from an IFR representation to an XML format that may be presented to a user via Internet browsing software. The converted information is then presented to a user via a user Interface (block 706).

As shown and described above in conjunction with FIGS. 3 and 4, the user interface 116 (FIG. 1) may include text corresponding to operands and graphics (e.g., a checkbox) corresponding to opcodes. When the IFR information is converted to, for example, XML graphical user interface information including checkboxes and the like, the memory contents corresponding to the graphics is noted. For example, the checkbox state shown in FIGS. 3 and 4 corresponds to the operand stored at memory location 0x0c. In other words, the state of the checkbox is represented by the information stored in memory location 0x0c. If the contents of the memory location 0x0c indicate a logical one, the checkbox will appear checked. Conversely, if the contents of the memory location 0x0c are a logical zero, the checkbox will appear as unchecked.

Once modification of the user interface (e.g., checking, unchecking or rechecking the checkbox) is allowed (block 708), a user via an Internet browser may modify the interface objects (e.g., XML objects) corresponding to configuration settings. For example, a user may check, uncheck or recheck the checkbox of FIGS. 3 and 4. Once the user is satisfied with the state of the configuration settings (e.g., the state of the checkbox of FIGS. 3 and 4), the user may submit the state of the user interface settings by clicking the submit button 306, 406 of FIGS. 3 or 4 (block 710 of FIG. 7).

Upon user indication of the desire to submit the settings, the user changes are received (block 712) and written to the memory or memories to which the settings correspond (block 714). As noted previously, when the interface objects are created, the memory locations to which the objects correspond are noted. Accordingly, when interface objects are modified and submitted by the user, the memory locations corresponding to those locations are modified to reflect the modifications indicated by the user.

When the states of the memory locations holding configuration information are changed to reflect the selections made and submitted by a user, the user interface presented to the user is modified to indicate that the changes are not pending (i.e., not submitted), but have actually been made to the memory locations holding configuration information (block 716). The user interface may be updated by changing the appearance of various items of the user interface. For example, when all changes made by the user have been submitted, the submit button (e.g., the submit button 306 or 406 of FIGS. 3 or 4) may be changed in appearance to appear to be unselectable by, for example, graying the button.

After the user interface has been updated, (block 716), the user may be prompted to quit the OS Agent process 606. If the user indicates a desire to quit (block 720), the process 606 terminates execution, thereby returning control to the configuration routine 600. Alternatively, if the user does not desire to quit, the user interface may be displayed to the user (block 706). The control of the process 606 flows between blocks 706 and 720 until the user manifests a desire to quit operation of the process 606.

Although certain apparatus constructed in accordance with the teachings of the invention have been described herein, the scope of coverage of this patent is not limited thereto. On the contrary, this patent covers all apparatuses, methods and articles of manufacture of the teachings of the invention fairly falling within the scope of the appended claims either literally or under the doctrine of equivalents.

What is claimed is:

1. A method of enabling system configuration during runtime, the method comprising:
retrieving configuration information in a first format from a database;
converting at least some of the configuration information from a first format into a second format;
providing a user interface through which at least some of the configuration information in the second format is displayed to a user;
accepting input from a user via an input device during runtime, wherein the input includes alterations to the configuration information; and
altering the configuration of the system based on the input.

2. A method as defined by claim 1, wherein the first format is based on an internal forms representation.

3. A method as defined by claim 2, wherein the internal forms representation includes operation codes and operands.

4. A method as defined by claim 3, wherein the second format is based on an extensible markup language.

5. A method as defined by claim 4, wherein the extensible markup language includes a plurality of user interface object representations.

6. A method as defined by claim 2, wherein the second format is based on a hypertext markup language.

7. A method as defined by claim 6, wherein the hypertext markup language includes a number of user interface object representations.

8. A method as defined by claim 1, further comprising populating the database with peripheral configuration information in a pre-boot environment.

9. A method as defined by claim 8, wherein converting at least some of the configuration information from the first format to the second format is performed during operating system runtime.

10. A method as defined by claim 1, further comprising generating a conversion table relating the configuration information in the second format to memory locations.

11. A method as defined by claim 10, wherein altering the configuration of the system based on the input includes writing information to memory locations.

12. A method as defined by claim 1, wherein the configuration information in the first format comprises information related to the configuration of a motherboard.

13. A method as defined by claim 12, wherein the configuration information in the first format comprises information related to the configuration of a peripheral interfaced to the motherboard.

14. An article of manufacture comprising a machine-accessible medium having a plurality of machine accessible instructions that, when executed, cause a machine to:
retrieve configuration information in a first format from a database;
convert at least some of the configuration information from a first format into a second format;
provide a user interface through which at least some of the configuration information in the second format is displayed to a user;
accept input from a user via an input device during runtime, wherein the input includes alterations to the configuration information; and
alter the configuration of the system based on the input.

15. A machine-accessible medium as defined by claim 14, wherein the first format is based on includes an internal forms representation.

16. A machine-accessible medium as defined by claim 15, wherein the internal forms representation includes operation codes and operands.

17. A machine-accessible medium as defined by claim 16, wherein the second format is based on an extensible markup language.

18. A machine-accessible medium as defined by claim 17, wherein the extensible markup language includes a number of user interface object representations.

19. A machine-accessible medium as defined by claim 15, wherein the second format is based on a hypertext markup language.

20. A machine-accessible medium as defined by claim 19, wherein the hypertext markup language includes a plurality of user interface object representations.

21. A machine-accessible medium as defined by claim 14, further comprising machine accessible instructions that, when executed, cause the machine to populate the database with peripheral configuration information in a pre-boot environment.

22. A machine-accessible medium as defined by claim 21, wherein converting at least some of the configuration information from the first format to the second format is performed during operating system runtime.

23. A machine-accessible medium as defined by claim 14, further comprising machine accessible instructions that, when executed, cause the machine to generate a conversion table relating the configuration information in the second format to memory locations.

24. A machine-accessible medium as defined by claim 23, wherein altering the configuration of the system based on the input includes writing information to memory locations.

25. A machine-accessible medium as defined by claim 14, wherein the configuration information in the first format comprises information related to the configuration of a motherboard.

26. A machine-accessible medium as defined by claim 25, wherein the configuration information in the first format comprises information related to the configuration of a peripheral interfaced to the motherboard.

27. A system comprising:
a database configured to store configuration information in a first format;
a data retriever configured to retrieve configuration information in the first format from the database;
a format converter configured to convert at least some of the configuration information from the first format into a second format;
a user interface server configured to receive the information in the second format during runtime and to provide a user interface through which at least some of the configuration information in the second format is displayed to a user;
a user response processor configured to accept input from a user via an input device, wherein the input includes alterations to the configuration information; and
a memory writer configured to alter the configuration of the system based on the input from the user.

28. A system as defined by claim 27, wherein the first format is based on an internal forms representation.

29. A system as defined by claim 28, wherein the internal forms representation includes operation codes and operands.

30. A system as defined by claim 29, wherein the second format is based on an extensible markup language.

31. A system as defined by claim 30, wherein the extensible markup language includes a number of user interface object representations.

32. A system as defined by claim 28, wherein the second format is based on a hypertext markup language.

33. A system as defined by claim 32, wherein the hypertext markup language includes a plurality of user interface object representations.

34. A system as defined by claim 27, further comprising populating the database with peripheral configuration information in a pre-boot environment.

35. A system as defined by claim 34, wherein converting at least some of the configuration information from the first format to the second format is performed during operating system runtime.

36. A system as defined by claim 27, further comprising generating a conversion table relating the configuration information in the second format to memory locations.

37. A system as defined by claim 36, wherein altering the configuration of the system based on the input includes writing information to memory locations.

38. A system as defined by claim 27, further comprising a motherboard and wherein the configuration information in the first format comprises information related to the configuration of the motherboard.

39. A system as defined by claim 38, further comprising a peripheral interfaced to the motherboard and wherein the configuration information in the first format comprises information related to the configuration of the peripheral interfaced to the motherboard.

40. An system comprising:
a processor;
a static random access memory device coupled to the processor; and
instructions stored on the static random access memory device that, when executed cause the processor to:
retrieve configuration information in a first format from a database;
convert at least some of the configuration information from a first format into a second format;
provide a user interface through which at least some of the configuration information in the second format is displayed to a user;
accept input from a user via an input device during runtime, wherein the input includes alterations to the configuration information; and
alter the configuration of the system based on the input.

41. A system as defined by claim 40, wherein the first format is based on an internal forms representation.

42. A system as defined by claim 40, wherein the second format is based on an extensible markup language.
